(19) United States
(12) Patent Application Publication
(10) Pub. No.: US 2020/0239369 A1
(43) Pub. Date: Jul. 30, 2020

(54) FUSED ALUMINA GRAINS, METHOD FOR PRODUCING FUSED ALUMINA GRAINS, GRINDSTONE, AND COATED ABRASIVE

(71) Applicant: SHOWA DENKO K.K, Tokyo (JP)

(72) Inventors: So MIYAISHI, Kawasaki-shi, Kanagawa (JP); Kazuaki TAKANO, Matsumoto-shi, Nagano (JP); Satoshi YAMAOKA, Yokohama-shi, Kanagawa (JP)

(73) Assignee: SHOWA DENKO K.K., Tokyo (JP)

(21) Appl. No.: 16/649,758

(22) PCT Filed: Oct. 25, 2018
(86) PCT No.: PCT/JP2018/039746

§ 371 Date: Mar. 23, 2020

(30) Foreign Application Priority Data
Dec. 19, 2017 (JP) 2017-243237

(51) Int. Cl. C04B 35/106; C09K 3/14

(52) U.S. Cl. CPC C04B 35/106; C09K 3/1409; C04B 2235/3258; C04B 2235/3256; C04B 2235/666

(57) ABSTRACT

Provided are electrofused alumina grains capable of preventing grain binding on production and of achieving high grinding performance. The electrofused alumina grains of the present invention contain at least either one of tungsten or molybdenum.

### TECHNICAL FIELD

The present invention relates to electrofused alumina grains and a method for producing the electrofused alumina grains, and to a grindstone and a coated abrasive including the electrofused alumina grains.

### BACKGROUND ART

Alumina abrasives specified in JIS R 6111-2005 are called artificial abrasives and used as a constituent element for abrasive grindstones, coated abrasives, and the like. As specified in JIS R 6111-2005, alumina abrasives include white fused alumina abrasives (WA), ruby fused alumina abrasives (PA), mono-crystalline fused alumina abrasives (HA), and the like. These are produced by fusing (i.e., electrofusing) an alumina material consisting of alumina purified by a Bayer process, in an electric furnace, then solidifying it, and grinding and size-regulating the resultant mass or crushing and size-regulating the mass. The toughness of these abrasives is in a relation of HA>PA>WA.

These conventional alumina abrasives may not have sufficient grinding performance in applications of grinding and machining hardly-machinable materials. Thus, improving grinding performance of alumina abrasives has been attempted (e.g., Patent Literatures 1 and 2).

Patent Literature 1 describes a method of improving grinding performance of alumina abrasives by heating high-purity fused alumina abrasive grains having an alumina content of 99.0% or more at 1600 to 1850° C. for 30 minutes to 2 hours. In grinding electrofused alumina ingots, defects, fine flaws, and cracks occur in the abrasive grains, and the crush strength of the abrasive grains decreases. The technique of Patent Literature 1 improves the crush strength of the abrasive grains by heating the abrasive grains under predetermined conditions to thereby facilitate atomic diffusion and rearrangement and evaporate Na₂O contained in the abrasive grains. However, grindstones including the abrasive grains in accordance with this technique are not able to provide sufficiently satisfactory grinding performance, and higher grinding performance is required.

The literature mentions that, in the case where fused alumina abrasive grains having a high content of impurities such as TiO₂ and SiO₂ are fired at a temperature of about 1000 to 1300° C., cracks in the abrasive grains are eliminated and the crushing strength of the abrasive grains increases, whereas, in the case where fused alumina abrasive grains having a high content of impurities are treated at a high temperature such as 1400° C. or higher, the strength rather decreases. The literature also mentions that, in the case where abrasive grains having a high content of impurities are treated at a high temperature, sintering of the abrasive grains (hereinbelow, grain binding) occurs and thus, crushing is required, which is troublesome.

Patent Literature 2 describes a method in which aluminum titanate is formed by subjecting electrofused alumina grains containing titanium oxide to heat treatment, and the surfaces of the electrofused alumina grains is coated with the formed aluminum titanate to thereby enhance the strength and toughness of the electrofused alumina grains. The literature discloses that the electrofused alumina grains produced by this method have a decrease in the C-coefficient (i.e., an increase in the toughness) and an increase in the micro-Vickers hardness. The literature also discloses that using the electrofused alumina grains as abrasive grindstones can achieve more excellent grinding performance than that of conventional white electrofused alumina abrasives and single-crystalline electrofused alumina abrasives. From this disclosure, it can be seen that enhancing the toughness and micro-Vickers hardness of electrofused alumina grains is effective for improving the grinding performance. However, as described in Examples of the literature, heat treatment of electrofused alumina grains containing titanium oxide leads to caking of the grains (i.e., causes grain binding). For this reason, there is a problem in that crushing is required and thus labor is entailed. There is also a problem in that this crushing leads to a decrease in the yield of electrofused alumina grains having an intended grain size.

### CITATION LIST

### Patent Literature

PTL 1: JP S50-80305A

PTL 2: JP H07-215717A

### SUMMARY OF INVENTION

### Technical Problem

As described above, conventional techniques have not provided electrofused alumina grains capable of preventing grain binding on production and of achieving high grinding performance. It is an object of the present invention to provide electrofused alumina grains capable of preventing grain binding on production and of achieving high grinding performance and a method for producing the electrofused alumina grains, and to a grindstone and a coated abrasive including electrofused alumina grains.

### Solution to Problem

The present inventors have intensively studied to have found that allowing electrofused alumina grains to contain at least either one of tungsten or molybdenum can prevent grain binding on production and achieve high grinding performance, having completed the present invention. That is, the present invention is as follows.

[1] Electrofused alumina grains comprising at least either one of tungsten or molybdenum.

[2] The electrofused alumina grains according to the above [1], wherein the total of a tungsten content in terms of WO₃ and a molybdenum content in terms of MoO₃ is 0.05 to 3.00% by mass.

[3] The electrofused alumina grains according to the above [1] or [2], comprising zirconium.

[4] The electrofused alumina grains according to the above [3], wherein a zirconium content in terms of ZrO₂ is 0.01 to 2.00% by mass in the electrofused alumina grains.

[5] The electrofused alumina grains according to the above [3] or [4], wherein the zirconium content in terms of ZrO₂ is 40 mol to 67 mol relative to 100 mol in total of the tungsten content in terms of WO₃ and the molybdenum content in terms of MoO₃.

[6] The electrofused alumina grains according to any one of the above [1] to [5], satisfying the following expression (1):

y<−1.506x+3.605 (1)

wherein x represents the C-stage bulk specific gravity of the electrofused alumina grains, and y represents the C-coefficient of the electrofused alumina grains.

[7] A method for producing electrofused alumina grains comprising step (A) of preparing a mixture material by mixing an alumina material and a material comprising at least either one of a tungsten compound or a molybdenum compound, step (B) of forming an ingot from the mixture material by an electrofusing process, step (C) of grinding the ingot to prepare a ground powder, step (D) of size-regulating the ground powder to have a predetermined grain size to prepare size-regulated grains, and step (E) of heating the size-regulated grains at a heating temperature of 1000° C. or higher to give electrofused alumina grains.

[8] The method for producing electrofused alumina grains according to the above [7], wherein the amount of the tungsten compound and the molybdenum compound blended in the step (A) of preparing the mixture material is such an amount that the content of the tungsten compound in terms of WO₃ and the molybdenum compound in terms of MoO₃ in the ingot is from 0.05 to 3.00% by mass.

[9] The method for producing electrofused alumina grains according to the above [7] or [8], wherein the step (A) preparing the mixture material is a step of preparing a mixture material by mixing an alumina material, a zirconium compound, and at least either one of a tungsten compound or a molybdenum compound.

[10] The method for producing electrofused alumina grains according to the above [9], wherein the amount of the zirconium compound blended in the step (A) of preparing the mixture material is such an amount that the zirconium content in terms of ZrO₂ in the ingot is from 0.01 to 2.00% by mass.

[11] The method for producing electrofused alumina grains according to the above [9] or [10], wherein the amount of the zirconium compound blended in the step (A) of preparing the mixture material is such an amount that the zirconium content in terms of ZrO₂ in the ingot is from 40 mol to 67 mol relative to 100 mol in total of the tungsten content in terms of WO₃ and the molybdenum content in terms of MoO₃.

[12] The method for producing electrofused alumina grains according to any one of the above [7] to [11], wherein the heating temperature in the step (E) of producing the electrofused alumina grains (E) is 1200° C. or higher and 1700° C. or lower.

[13] A grindstone comprising the electrofused alumina grains according to any one of the above [1] to [6].

[14] A coated abrasive comprising the electrofused alumina grains according to any one of the above [1] to [6].

### Advantageous Effect of Invention

According to the present invention, there can be provided electrofused alumina grains causing no grain binding on production and having excellent grinding performance and a method for producing the electrofused alumina grains, as well as a grindstone and a coated abrasive including the electrofused alumina grains.

### BRIEF DESCRIPTION OF DRAWINGS

FIG. 1 is a graph drawn by plotting the C-stage bulk specific gravity and the C-coefficient of Examples 1 to 8 and Comparative Examples 1 to 3, in which graph the horizontal axis indicates the C-stage bulk specific gravity of electrofused alumina grains and the vertical axis indicates the C-coefficient of the electrofused alumina grains.

FIG. 2 is a graph showing an approximate linear function derived from the results of measurement of SA abrasive grains in three grain sizes: F36, F80, and F120 (manufactured by Showa Denko K. K.), as specified in JIS R 6001-1998, in which measurement 20 grains of each grain size were measured. The SA abrasive grains are alumina single-crystal abrasive grains, and are an abrasive mainly used for grinding and machining hardly machinable materials. The SA abrasive grains contain 99.6% by mass of Al₂O₃, 0.03% by mass of SiO₂, 0.03% by mass of Fe₂O₃, and 0.3% by mass of TiO₂.

FIG. 3 shows photographs showing the results of element mapping analysis by energy-dispersive X-ray spectroscopy of Example 4.

### DESCRIPTION OF EMBODIMENT

Hereinbelow, the present invention will be described in detail, but the present invention is not limited to the following embodiment. In the following description, the phrase “A to B” referring to a numerical range indicates a numerical range including A and B that are the end points. That is, it means a numerical range of “A or more and B or less” (in the case of A<B) or “A or less and B or more” (in the case of A>B).

### [Electrofused Alumina Grains]

In this description, the electrofused alumina grains are alumina grains obtained by fusing and solidifying a material of alumina and the like, as purified by a Bayer process, in an electric furnace such as an arc furnace or the like to provide an ingot, and pulverizing and size-regulating the ingot, or alumina grains obtained by crushing and size-regulating the ingot.

The electrofused alumina grains of the present invention contain at least either one of tungsten or molybdenum. Accordingly, the electrofused alumina grains causing no grain binding on production and having excellent grinding performance can be provided.

The electrofused alumina grains of the present invention preferably further contain zirconium.

### (Tungsten and Molybdenum Content)

The total of the tungsten content in terms of WO₃ and the molybdenum content in terms of MoO₃ is preferably 0.05 to 3.00% by mass, more preferably 0.10 to 2.50% by mass, further preferably 0.20 to 2.00% by mass. The content herein means a content determined by the analysis method described in Examples mentioned below.

By setting the total of the tungsten content in terms of WO₃ and the molybdenum content in terms of MoO₃ to 0.05% by mass or more, higher toughness can be achieved.

By setting the total of the tungsten content in terms of WO₃ and the molybdenum content in terms of MoO₃ to 3.00% by mass or less, high hardness originally possessed by alumina can be maintained.

By setting the total of the tungsten content in terms of WO₃ and the molybdenum content in terms of MoO₃ within a range of 0.05 to 3.00% by mass, high hardness and high toughness can be simultaneously provided.

Simultaneously providing high hardness and high toughness enables excellent grinding performance to be achieved.

### (Effect of Tungsten and Molybdenum on Prevention of Grain Binding)

The fact that occurrence of grain binding on production can be avoided when at least either one of tungsten or molybdenum is contained in the electrofused alumina grains is presumed to be due to the following principle. In the electrofused alumina grains as described in Patent Literature 2, the titanium compound, which is relatively highly reactive with alumina on heat treatment, precipitates on the surface of the grains, and consequently, grain binding occurs. Meanwhile, in the present invention, at least either one of tungsten or molybdenum, which is relatively low reactive with alumina, is contained. Thus, it is expected that no grain binding occurs after heat treatment, and additionally, as a result of high hardness and high toughness simultaneously provided, the grinding performance is excellent.

### (Zirconium Content)

The zirconium content in terms of ZrO₂ in the electrofused alumina grains is preferably 0.01 to 2.00% by mass, more preferably 0.02 to 1.75% by mass, further preferably 0.03 to 1.50% by mass. The content herein means a content determined by the analysis method described in Examples mentioned below.

By setting the zirconium content in terms of ZrO₂ to 0.01% by mass or more, higher toughness due to co-addition can be achieved.

By setting the zirconium content in terms of ZrO₂ to 2.00% by mass or less, high hardness originally possessed by alumina can be maintained.

The zirconium content in terms of ZrO₂ is preferably 40 to 67 mol, more preferably 42 to 63 mol, further preferably 43 to 59 mol relative to 100 mol in total of the tungsten content in terms of WO₃ and the molybdenum content in terms of MoO₃.

By setting the zirconium content to 40 mol or more relative to 100 mol in total of the tungsten content in terms of WO₃ and the molybdenum content in terms of MoO₃, sufficient higher toughness due to co-addition can be confirmed.

By setting the zirconium content to 67 mol or less relative to 100 mol in total of the tungsten content in terms of WO₃ and the molybdenum content in terms of MoO₃, no grain binding occurs on production, and additionally, high Vickers hardness originally possessed by alumina can be maintained.

### (Effect of Tungsten and Molybdenum on Improvement of Grinding Performance)

The fact that grinding performance of the electrofused alumina grains is improved when at least either one of tungsten or molybdenum is contained in the electrofused alumina grains is presumed to be due to the following principle. A portion of tungsten and molybdenum present in the inside, on the grain boundary, and on the surface of the electrofused alumina grains is expected to be present as ZrW₂O₈ and ZrMo₂O₈, which have a negative coefficient of thermal expansion. This causes compression stress to be applied on the electrofused alumina grains after heat treatment to thereby provide higher toughness. Tungsten and molybdenum scarcely dissolve as solid inside alumina, and thus the hardness also does not decrease.

### (C-Coefficient and C-Stage Bulk Specific Gravity)

The electrofused alumina grains of the present invention preferably satisfy the following expression (1), more preferably satisfy the following expression (2), even more preferably satisfy the following expression (3), particularly preferably satisfy the following expression (4), most preferably satisfy the following expression (5), wherein x indicates the C-stage bulk specific gravity of the electrofused alumina grains, and y indicates the C-coefficient of the electrofused alumina grains. Accordingly, the grinding performance of the electrofused alumina grains of the present invention can be enhanced.

y<−1.506x+3.605 (1)

y<−1.506x+3.595 (2)

y<−1.506x+3.585 (3)

<−1.506x+3.575 (4)

y<−1.506x+3.565 (5)

The C-coefficient is the same as the C-coefficient defined in JIS R6128-1987 (Ball mill test for toughness of artificial abrasives). The method for measuring the C-coefficient is described in detail in the section of Examples mentioned below.

Regarding the C-stage bulk specific gravity, the bulk specific gravity of the sample remaining on the 3rd-stage sieve, sieved using a standard sieve specified in JIS R6001-1987, on measurement of the C-coefficient thereof is defined as a value of the C-stage bulk specific gravity measured by the method specified in JIS R6126-1970. The method for measuring the C-stage bulk specific gravity is described in detail in the section of Examples mentioned below.

Generally, the smaller the grain size, the smaller the value of the C-stage bulk specific gravity, and the larger the grain size, the larger the value of the C-stage bulk specific gravity. However, in the case of a sample that has been size-regulated to have an equivalent grain size as the electrofused alumina grains, the C-stage bulk specific gravity may change depending on the shape of the grains. With larger quantities of sharp grains or flat grains, a rate of free-fall filling is lower, and thus the C-stage bulk specific gravity is smaller. With larger quantities of nearly spherical grains, a rate of free-fall filling is higher, and thus the C-stage bulk specific gravity thereof is larger.

There is a negative correlation between the C-coefficient and the C-stage bulk specific gravity (see FIG. 2). As mentioned above, a sample having a small C-stage bulk specific gravity contains large quantities of sharp grains and flat grains. Accordingly, when the C-coefficient is measured using the sample, grinding in a ball mill readily proceeds to thereby lead to a larger value of the C-coefficient thereof (lower toughness). In contrast, a sample having a large C-stage bulk specific gravity contains large quantities of nearly spherical grains. For this reason, when the C-coefficient is measured using these, grinding in a ball mill is unlikely to proceed to thereby lead to a smaller value of the C-coefficient (higher toughness).

As mentioned above, the electrofused alumina grains of the present invention preferably satisfy the expression (1) mentioned above. Considering that x>0 and y>0, the region of the x (C-stage bulk specific gravity)−y (C-coefficient) plane, satisfying the expression (1) mentioned above, is a region in which both the value of x (C-stage bulk specific gravity) and the value of y (C-coefficient) are small values. This indicates that the electrofused alumina grains of the present invention are sharp grains or flat grains, and the electrofused alumina grains of the present invention have high toughness. From the fact that sharp grains and flat grains have higher grinding performance than nearly spherical grains and that grains having higher toughness have higher grinding performance, it can be seen that the electrofused alumina grains of the present invention satisfying the expression (1) mentioned above have higher grinding performance.

(Other Elements than Aluminum, Oxygen, Titanium and Magnesium)

The electrofused alumina grains of the present invention may comprise any other elements than aluminum, oxygen, zirconium, tungsten, and molybdenum. The total content of the other elements than aluminum, oxygen, zirconium, tungsten, and molybdenum in the electrofused alumina grains of the present invention is preferably 1.5 atomic molar % or less in terms of oxides thereof. When the total content of the other elements than aluminum, oxygen, zirconium, tungsten, and molybdenum is 1.5 atomic molar % or less in terms of oxides thereof, the electrofused alumina grains of the present invention have sufficient grinding performance. The total content of the other elements than aluminum, oxygen, zirconium, tungsten, and molybdenum is more preferably 1.0 atomic molar % or less in terms of oxides thereof, even more preferably 0.5 atomic molar % or less in terms of oxides thereof, most preferably 0 atomic molar % in terms of oxides thereof. Examples of the other elements than aluminum, oxygen, zirconium, tungsten, and molybdenum include sodium, silicon, calcium, iron, and chromium.

### [Method for Producing Electrofused Alumina Grains]

A method for producing electrofused alumina grains of the present invention comprise step (A) of preparing a mixture material by mixing an alumina material and a material comprising at least either one of a tungsten compound or a molybdenum compound, step (B) of forming an ingot from the mixture material by an electrofusing process, step (C) of grinding the ingot to prepare a ground powder, step (D) of size-regulating the ground powder to have a predetermined grain size to prepare size-regulated grains, and step (E) of heating the size-regulated grains at a heating temperature of 1000° C. or higher to give electrofused alumina grains. Accordingly, there can be provided electrofused alumina grains of the present invention capable of avoiding occurrence of grain binding on production and having excellent grinding performance.

### (Step (A))

In the step (A), an alumina material and a material comprising at least either one of a tungsten compound or a molybdenum compound are mixed to prepare a mixture material. For example, an alumina material and a material comprising at least either one of a tungsten compound or a molybdenum compound as weighed in a predetermined blending ratio are mechanically mixed using a mixer, a ball mill, or the like or by manually mixed using a shovel or the like.

In the step (A), it is preferable to mix an alumina material, a zirconium compound, and at least either one of a tungsten compound or a molybdenum compound to prepare a mixture material.

### <Alumina Material>

Examples of the alumina material for use in the method for producing electrofused alumina grains of the present invention include alumina purified by a Bayer process.

### <Tungsten Compound and Molybdenum Compound>

Examples of the tungsten compound for use in the method for producing electrofused alumina grains of the present invention include tungsten oxides, tungsten, tungsten sulfide, ammonium tungstate, and tungstic acid. Among these, in particular, tungsten trioxide as a tungsten oxide is preferably used.

Examples of the molybdenum compound for use in the method for producing electrofused alumina grains of the present invention include molybdenum oxides, molybdenum, molybdenum sulfide, ammonium molybdate, ammonium dimolybdate, hexammonium heptamolybdate, and molybdic acid. Among these, in particular, molybdenum trioxide as a molybdenum oxide is preferably used.

The amount of the tungsten compound and the molybdenum compound blended in the step (A) is preferably such an amount that the content of tungsten in terms of WO₃ and molybdenum in terms of MoO₃ in the ingot is from 0.05 to 3.00% by mass, more preferably such an amount that the content is from 0.10 to 2.50% by mass, further preferably such an amount that the content is from 0.20 to 2.00% by mass.

### <Zirconium Compound>

Examples of the zirconium compound for use in the method for producing electrofused alumina grains of the present invention include zirconium oxide, zirconium, zirconium carbonate, zirconium sulfate, and zirconium sulfide. Of these, in particular, zirconium oxide is preferably used.

The amount of the zirconium compound blended in the step (A) is preferably such an amount that the zirconium content in terms of ZrO₂ in the ingot is from 0.01 to 2.00% by mass, more preferably such an amount that the zirconium content is 0.02 to 2.00% by mass, further preferably such an amount that the zirconium content is 0.03 to 1.75% by mass.

The amount of the zirconium compound blended in the step (A) is preferably such an amount that the zirconium content in terms of ZrO₂ in the ingot is from 40 to 67 mol, more preferably such an amount that the zirconium content is 42 to 63 mol, further preferably such an amount that the zirconium content is 43 to 59 mol, particularly preferably such an amount that the zirconium content is 45 to 56 mol, relative to 100 mol in total of the tungsten content in terms of WO₃ and the molybdenum content in terms of MoO₃.

### (Step (B))

In the step (B), an ingot is formed from the mixture material by an electrofusing method. The electrofusing method is a method of fusing the mixture material using an electric furnace such as an electric arc furnace at a heating temperature of, for example, about 2000 to about 2500° C. After completion of fusing, for example, the electric furnace is inclined, and the molten material is discharged out from the pour spout positioned through the furnace wall, and cast into a mold or the like provided in advance to produce an ingot. The ingot is polycrystalline alumina.

### (Step (C))

In the step (C), the ingot is ground to prepare a ground powder. The ingot is roughly broken using a roll breaker, a drop hammer or the like, for example, then visually screened, and thereafter ground using a grinding apparatus such as an impeller breaker, a jaw crusher, a roll crusher, an edge runner, or a conical ball mill. The particle size of the ground powder is preferably set within a range of 50 μm to 8 mm in accordance with the grain size required in each product.

### (Step (D))

In the step (D), the ground powder is size-regulated to have a predetermined grain size to prepare size-regulated grains. For example, when the electrofused alumina grains to be produced correspond to rough grains specified in JIS R 6001-1998, the ground powder is size-regulated to have a predetermined grain size via a sieving step. Alternatively, when the electrofused alumina grains to be produced correspond to a fine powder specified in JIS R 6001-1998, the ground powder is further finely powdered using a ball mill, an air mill or the like, and then the resultant fine powder is size-regulated to have a predetermined grain size via a purification step.

### (Step (E))

In the step (E), the size-regulated grains are heated at a heating temperature of 1000° C. to 1900° C. to provide electrofused alumina grains.

Accordingly, the strength and the toughness of the electrofused alumina grains can be enhanced.

For example, the size-regulated grains are placed in a container such as a sagger and heated in an electric furnace such as a muffle furnace or a tunnel-type continuous firing furnace, or the size-regulated grains are directly heated in a firing apparatus such as a rotary kiln.

The heating temperature in the step (E) is 1000 to 1900° C., preferably 1000 to 1800° C., more preferably 1200 to 1600° C., further preferably 1300 to 1500° C.

When the heating temperature is 1000° C. or higher, the strength of the electrofused alumina increases. When the heating temperature is 1900° C. or lower, the size-regulated grains can be heated without sintering of the grains. The retention time for heating in the heat treatment is preferably 60 minutes or more. The atmosphere in the heat treatment is preferably an air atmosphere.

### (Other Steps)

Between the step (C) and the step (D), a step of removing impurities such as fine powder and magnetic material formed in the step (C), and a steps of washing with acid and/or washing with water may be added as required. Accordingly, impurities can be prevented from diffusing inside the size-regulate grains in the heat treatment of the step (E).

After the step (E), the resultant electrofused alumina grains may be further size-regulated. The size-regulation method may be, for example, the same method as that of the step (D). Accordingly, electrofused alumina grains having a more regulated grain size can be provided.

### [Grindstone]

The grindstone of the present invention comprises the electrofused alumina grains of the present invention. Accordingly, a grindstone having excellent grinding performance can be provided. Specifically, the grindstone of the present invention is a product obtained by binding the electrofused alumina grains of the present invention with a binder, and is composed mainly of the electrofused alumina grains, the binder, and pores. The grindstone is produced by molding and hardening the electrofused alumina grains with a binder such as a vitrified bond, a metal bond, or a resin bond. The binder is preferably a vitrified bond. The vitrified bond is generally called frit, as prepared by adequately blending feldspar, china stone, borax, clay, and the like, and examples of the components thereof include SiO₂, B₂O₃, Al₂O₃, Fe₂O₃, CaO, MgO, Na₂O, and K₂O. A grindstone obtained using a vitrified bond (vitrified grindstone) is produced by adding a small amount of a molding aid such as dextrin or phenolic resin to a vitrified bond, mixing it with electrofused alumina grains, and press-molding and then firing the mixture. The firing temperature is preferably 950 to 1150° C. The electrofused alumina grains of the present invention can also be used as abrasive grains for grindstones such as a resinoid grindstone, a rubber grindstone, a silicate grindstone, a shellac grindstone, and a magnesia grindstone, in addition to the vitrified grindstone.

### [Coated Abrasive]

The coated abrasive of the present invention comprises the electrofused alumina grains of the present invention. Accordingly, a coated abrasive having excellent grinding performance can be provided. The coated abrasive can be produced by bonding electrofused alumina grains to a substrate with an adhesive. A preferred adhesive is a phenolic resin adhesive because of providing excellent abrasive performance and having excellent waterproofness. When resorcinol or a derivative thereof is used in combination with a phenolic resin adhesive, the curing condition for the phenolic resin adhesive can be relaxed. Examples of the substrate include paper, woven fabric, and nonwoven fabric. For a grinding belt for heavy grinding and the like, a woven fabric of polyester fibers may also be used. Additionally, as an nonwoven abrasive fabric, a nonwoven fabric of synthetic fibers such as nylon can be used as the substrate. The coated abrasive includes, as specified in JIS as product standards, an abrasive cloth (R6251-2006), an abrasive paper (R6252-2006), a waterproof abrasive paper (R6253-2006), an abrasive disc (R6255-2014), an abrasive belt (R6256-2006) coated abrasives—cylindrical sleeve (R6257-2006), and the like. However, the coated abrasive of the present invention is not limited to these. An important application of the coated abrasive of the present invention, among applications not specified in JIS, is a nonwoven abrasive fabric. This is a flexible polishing material (polishing cloth) for a polishing nonwoven fabric composed of three constituent elements of a polishing material, fibers (nylon, polyester fibers, etc.) and an adhesive. This has a three-dimensional network structure of irregularly intercrossing constituent element fibers and a large-volume connected voids, has a thickness of 2 to 8 mm or so, and has structural characteristics of excellent flexibility and compression restorability.

### EXAMPLES

The present invention is described more specifically with reference to Examples and Comparative Examples given hereinbelow, but the present invention is not restricted by these Examples in any way.

### [Evaluation of Electrofused Alumina Grains of Examples and Comparative Examples]

The electrofused alumina grains of Examples and Comparative Examples were evaluated as follows.

### (C-Stage Bulk Specific Gravity)

In accordance with JIS R6126-1970, the C-stage bulk specific gravity was determined using an apparatus composed of a funnel, a stopper, and a cylinder and a support therefor by a process mentioned below.

(1) The volume V (ml) of the cylinder was measured.
(2) The outlet port of the funnel was plugged with a stopper, about 120 ml of a sample was placed into the funnel, and the cylinder was disposed immediately below the funnel.
(3) The stopper was withdrawn to drop the total amount of the sample down into the cylinder, the sample banked up on the top of the cylinder was removed by lightly scooping it, and then the weight of the sample put in the cylinder was measured.
(4) The operation of (2) and (3) was repeated for the same sample to obtain three measured values: W1 (g), W2 (g), and W3 (g).
(5) From the volume V (ml) of the cylinder obtained in (1), and the three measured values: W1 (g), W2 (g), and W3 (g) obtained in (4), the C-stage bulk specific gravity was calculated by the following expression (7).

C-Stage Bulk Specific Gravity(g/ml)={(W1+W2+W3)/3}/V (7)

### (C-Coefficient)

Using a standard sieve specified in JIS R6001-1987, 250 g of electrofused alumina grains were sieved by a ro-tap tester for 10 minutes. The total amount of the sample remaining on the 3rd stage sieve was further sieved for 10 minutes, and 100 g of the electrofused alumina grains remaining again on the 3rd stage sieve was used as a test sample. The test sample was ground with a ball mill by the method specified in JIS R6128-1975 to prepare a ground sample. The ground sample was sieved using a standard sieve for 5 minutes, and the weight of the ground sample remaining on the 4th sieve was referred to as R (x). As a standard sample, a black silicon carbide abrasive F 60 specified in JIS R6128-1975 was subjected to the same operation as above, and after grinding with a ball mill, the weight of F60 remaining on the 4th stage sieve was referred to as R(s). The C-coefficient was calculated by the following expression (6).

C-coefficient=log(100/R(x))/log(100/R(s)) (6)

When the degree of grinding with a ball mill is smaller (that is, when the toughness is higher), R (x) is larger, and thus, a sample having higher toughness shows a smaller value of the C-coefficient.

### (Micro-Vickers Hardness)

Using a hardness tester, model name MVK-VL, manufactured by Akashi Corporation as an apparatus, measurement was performed under conditions of a load of 0.98 N and an injection time of an indenter of 10 seconds, and the average value of the measured values at 15 points was taken as the micro-Vickers hardness.

### (Grain Binding)

Electrofused alumina grains size-regulated to F60 specified in JIS R6001-1998 before heat treatment were placed in a sagger and heated at 1500° C. for an hour. Sieved were 500 g of the resultant electrofused alumina abrasive grains using a sieve having an opening of 500 μm for a minute while impact was applied by a ro-tap tester. Thereafter, the mass of the electrofused alumina abrasive grains on the sieve was weighed. In the case where the mass was 5 g or more, it was determined that grain binding was present.

### (Element Mapping by Energy-Dispersive X-Ray Spectroscopy)

The composite sintered body prepared in Example 4 was allowed to be contained in a transparent resin powder (acrylic resin manufactured by Refine Tec Ltd.: 95 to 100% by mass, methyl methacrylate: 0 to 5% by mass, dibenzoyl peroxide: 0 to 1% by mass). This resin was thermoset-molded and then cut, and the section was mirror-polished and platinum-deposited. The section comprising a sample surface was subjected to element mapping analysis. The distribution state of tungsten and zirconium elements on the polished surface of Example 4 was measured via element mapping analysis using an energy dispersive X-ray spectrometer (model name JED-2300, manufactured by JEOL Ltd.).

### [Electrofused Alumina Grains of Examples and Comparative Examples]

Materials were each blended such that the content of the materials corresponded to the values shown in Table 1, and the blend was mixed with a Bayer-process alumina powder to prepare a mixture material. Then, the mixture material was fused in an electric arc furnace (fusing conditions: power consumption of the electric arc furnace: 9.0 kWh, heating time: 20 minutes, and atmosphere gas: air), and the resultant melt was cooled to provide an ingot.

The materials used were as follows.

Titanium oxide: manufactured by KANTO CHEMICAL CO., INC., “Titanium(IV) oxide, Rutile form”, grade “special grade”

Zirconium oxide: manufactured by KANTO CHEMICAL CO., INC., “zirconium oxide, 3N”, grade “high purity reagent”

Molybdenum oxide: manufactured by KANTO CHEMICAL CO., INC., “molybdenum oxide (VI)”, grade “Cica special grade”

Tungsten oxide: manufactured by KANTO CHEMICAL CO., INC., “tungsten oxide (VI)”, grade “Cica first grade”

A jaw crusher was used to roughly grind the resultant ingot, and thereafter, the roughly ground ingot was ground in a roll mill to prepare a ground powder. Then, using a sieve mesh having an opening corresponding to the grain size F80 specified as the grain size of abrasive in JIS R6001-1998, the ground powder was size-regulated to prepare size-regulated grains.

Placed were 300 g of the grains size-regulated to a grain size F80 in an alumina crucible. Then the grains were heated up to 1500° C. in an electric furnace (in air atmosphere) over three hours and kept at 1500° C. for an hour. The heating was stopped and the grains were left to cool in the furnace. After cooled to room temperature, the resultant grains were size-regulated using a sieve mesh of 250 to 150 μm to remove coarse grains formed by caking of the grains and fine grains, thereby providing electrofused alumina grains of Examples 1 to 10 and electrofused alumina grains of Comparative Examples of 1 to 3 corresponding to an F80-grade alumina abrasive.

In Comparative Example 1, SA abrasive grains having the F80 grain size manufactured by Showa Denko K. K. were used. The SA abrasive grains are alumina single-crystal abrasive grains, and are an abrasive mainly used for grinding and machining hardly machinable materials. The SA abrasive grains contain 99.6% by mass of Al₂O₃, 0.03% by mass of SiO₂, 0.03% by mass of Fe₂O₃, and 0.3% by mass of TiO₂.

In Comparative Example 2, WA abrasive grains having the F80 grain size manufactured by Showa Denko K. K. were used. The WA abrasive grains are white electrofused alumina abrasive grains, and are an abrasive suitable for applications in which heat generation should be avoided. The WA abrasive grains contain 99.8% by mass of Al₂O₃, 0.02% by mass of SiO₂, 0.02% by mass of Fe₂O₃, and the balance of 0.16% by mass comprises Na₂O.

### (Chemical Analysis)

The tungsten content in terms of WO₃, the molybdenum content of in terms of MoO₃, the zirconium content in terms of ZrO₂, and the titanium content in terms of TiO₂ in the electrofused alumina grains of Examples and Comparative Examples were measured by a fluorescent X-ray elementary analysis method. The measurement apparatus used was “ZSX Primus” manufactured by Rigaku Corporation.

The measurement results are shown in Table 1.

All the mass ratios in Table 1 mean weight ratios based on the weight of the alumina grains.

TABLE 1

| | Weight ratio | Weight ratio | Weight ratio | Weight ratio | Content of ZrO₂ | Firing |
|---|---|---|---|---|---|---|
| | of WO₃ | of MoO₃ | of ZrO₂ | of TiO₂ | (mol/total mol of | temperature |
| | (% by mass) | (% by mass) | (% by mass) | (% by mass) | WO₃ and MoO₃) | (° C.) |
| Example 1 | 0.70 | | | | | 1500 |
| Example 2 | | 0.61 | | | | 1500 |
| Example 3 | 0.16 | | 0.05 | | 59 | 1500 |
| Example 4 | 0.67 | | 0.19 | | 53 | 1500 |
| Example 5 | 1.16 | | 0.38 | | 62 | 1500 |
| Example 6 | | 0.18 | 0.09 | | 58 | 1500 |
| Example 7 | | 0.59 | 0.27 | | 53 | 1500 |
| Example 8 | | 1.22 | 0.55 | | 53 | 1500 |
| Example 9 | | 0.19 | | | | 1500 |
| Example 10 | | 1.21 | | | | 1500 |
| Comparative | | | | 0.26 | | 1500 |
| Example 1 | | | | | | |
| Comparative | | | | | | Not applied |
| Example 2 | | | | | | |
| Comparative | | | 0.18 | | | 1500 |
| Example 3 | | | | | | |

### [Evaluation Results]

The evaluation results of the C-stage bulk specific gravity (“C-Stage bulk” in the table), C-coefficient, micro-Vickers hardness, and grain binding of the electrofused alumina grains of Examples 1 to 10 and the electrofused alumina grains of Comparative Examples 1 to 3 are shown in the following Table 2.

TABLE 2

| | C-Stage | | Micro- | Grain binding (mass |
|---|---|---|---|---|
| | bulk | | Vickers | of electrofused |
| | specific | | hardness | alumina abrasive |
| | gravity | C-Coefficient | (GPa) | grains on sieve) |
| Example 1 | 1.63 | 1.02 | 20.3 | No (0.1 g or less) |
| Example 2 | 1.65 | 1.06 | 20.7 | No (0.1 g or less) |
| Example 3 | 1.63 | 1.09 | 20.6 | No (0.1 g or less) |
| Example 4 | 1.63 | 0.96 | 20.4 | No (0.1 g or less) |
| Example 5 | 1.60 | 1.06 | 20.0 | No (0.1 g or less) |
| Example 6 | 1.69 | 1.00 | 20.3 | No (0.1 g or less) |
| Example 7 | 1.67 | 1.00 | 20.2 | No (0.1 g or less) |
| Example 8 | 1.64 | 0.98 | 20.8 | No (0.1 g or less) |
| Example 9 | 1.64 | 1.08 | 20.8 | No (0.1 g or less) |
| Example 10 | 1.63 | 1.08 | 20.5 | No (0.1 g or less) |
| Comparative | 1.63 | 1.15 | 20.5 | Yes (130 g) |
| Example 1 | | | | |
| Comparative | 1.63 | 1.47 | 20.4 | No (0.1 g or less) |
| Example 2 | | | | |
| Comparative | 1.64 | 1.23 | 20.4 | No (0.1 g or less) |
| Example 3 | | | | |

From the comparison between Examples 1 to 10 and Comparative Examples 1 to 3, it can be confirmed that no grain binding occurred even due to heat treatment on production of electrofused alumina grains and electrofused alumina grains having excellent grinding performance were provided by containing at least either one of tungsten or molybdenum.

From the comparison between Example 1 and Example 4, it can be confirmed that co-addition of tungsten and zirconium lowered the C-coefficient more than addition of tungsten alone, that is, the electrofused alumina grains became robuster.

From the comparison between Example 2 and Example 7, it can be confirmed that co-addition of molybdenum and zirconium lowered the C-coefficient more than in the case of addition of molybdenum alone, that is, the electrofused alumina grains became robuster.

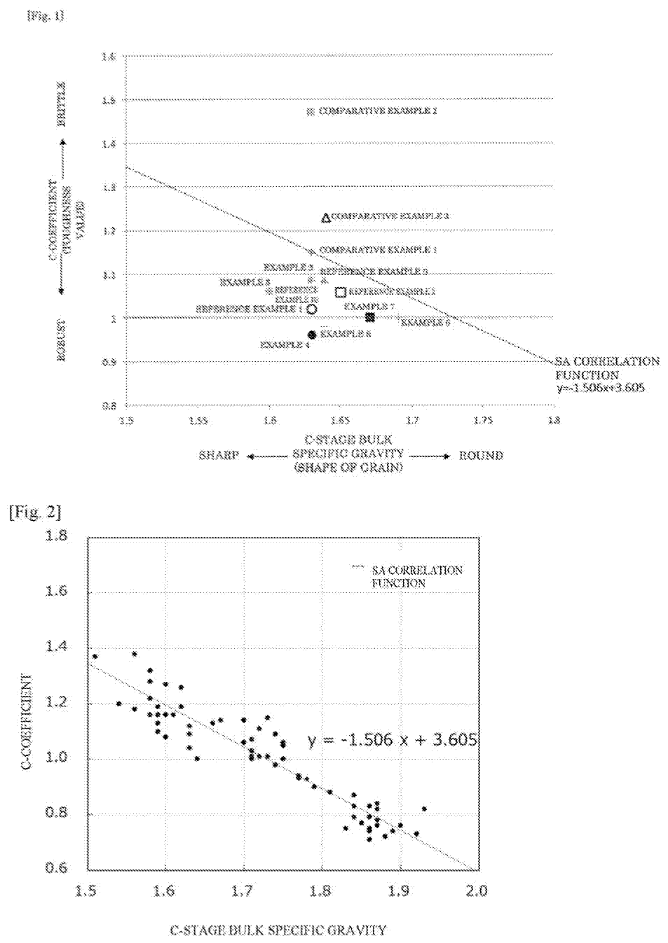

A graph drawn by plotting the C-stage bulk specific gravity and the C-coefficient of Examples 1 to 10 and Comparative Examples 1 to 3 is shown in FIG. 1, in which graph the horizontal axis indicates the C-stage bulk specific gravity of the electrofused alumina grains and the vertical axis indicates the C-coefficient of the electrofused alumina grains. From this graph, it can be confirmed that the electrofused alumina grains of Examples 1 to 10 satisfy the expression (1) mentioned above and have excellent grinding performance.

As described above, there is a negative correlation between the C-coefficient and the C-stage bulk specific gravity. When the correlation is shown as a graph where the horizontal axis indicates the C-stage bulk specific gravity and the vertical axis indicates the C-coefficient, the correlation can be expressed as a positive linear function where the inclination is negative and the section is positive. Samples of the same abrasive material having a different grain size and a different C-stage bulk specific gravity are distributed in the vicinity of almost one and the same linear line. As an example, an approximate linear function derived from the results of measurement of SA abrasive grains in three grain sizes: F36, F80, and F120 (manufactured by Showa Denko K. K.), in which measurement 20 grains of each grain size were measured, is shown in FIG. 2.

Here, “high-performance abrasive grains” are defined as those having a sharp form (i.e., having a small bulk specific gravity) and having high toughness (i.e., also having a small C-coefficient value). In other words, this means that the abrasive grains present in the lower left in the graph of FIG. 2 have higher performance. Specifically, mono-crystalline electrofused alumina abrasives containing a titanium oxide content in terms of TiO₂ of 0.30% by mass (SA manufactured by Showa Denko K. K.) satisfy the correlation shown in FIG. 2, and the approximate linear function thereof is expressed by the following expression (9):

y=−1.506x+3.605 (9)

wherein x represents the C-stage bulk specific gravity, and y represents the C-coefficient.

The electrofused alumina grains of Examples 1 to 10 satisfy the expression (1) mentioned above, which means that the electrofused alumina grains of Example 1 to 10 are high-performance abrasive grains containing larger quantities of sharp grains and flat grains as compared with the SA abrasive grains mentioned above (high-performance product) and also being excellent in toughness and have also more excellent grinding performance than that of the SA abrasive grains mentioned above (high-performance product). This is considered to be correct from the fact that, in FIG. 1, Comparative Example 2 and Comparative Example 3 do not fall within the range that satisfies the expression (1).

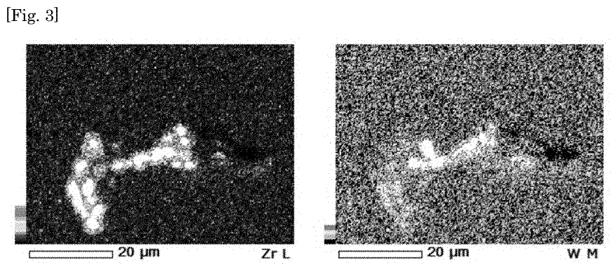

The results of the element mapping analysis by energy-dispersive X-ray spectroscopy of Example 4 are shown in FIG. 3. These results have revealed that a portion of tungsten and zirconium is present in the same region, suggesting that the portion is present in a state of a tungsten-zirconium compound.

1. Electrofused alumina grains comprising zirconium and at least either one of tungsten or molybdenum, wherein the total of a tungsten content in terms of WO₃ and a molybdenum content in terms of MoO₃ is 0.05 to 3.00% by mass.

2-3. (canceled)

4. The electrofused alumina grains according to claim 1, wherein a zirconium content in terms of ZrO₂ is 0.01 to 2.00% by mass in the electrofused alumina grains.

5. The electrofused alumina grains according to claim 1, wherein the zirconium content in terms of ZrO₂ is 40 mol to 67 mol relative to 100 mol in total of the tungsten content in terms of WO₃ and the molybdenum content in terms of MoO₃.

6. The electrofused alumina grains according to claim 1, satisfying the following expression (1):
y<−1.506x+3.605 (1)
wherein x represents the C-stage bulk specific gravity of the electrofused alumina grains, and y represents the C-coefficient of the electrofused alumina grains.

7. A method for producing electrofused alumina grains comprising:
step (A) of preparing a mixture material by mixing an alumina material, a zirconium compound, and a at least either one of a tungsten compound or a molybdenum compound,
step (B) of forming an ingot from the mixture material by an electrofusing process,
step (C) of grinding the ingot to prepare a ground powder,
step (D) of size-regulating the ground powder to have a predetermined grain size to prepare size-regulated grains, and
step (E) of heating the size-regulated grains at a heating temperature of 1000° C. or higher and 1900° C. or lower to give electrofused alumina grains.

8. The method for producing electrofused alumina grains according to claim 7, wherein the amount of the tungsten compound and the molybdenum compound blended in the step (A) of preparing the mixture material is such an amount that the content of the tungsten compound in terms of WO₃ and the molybdenum compound in terms of MoO₃ in the ingot is from 0.05 to 3.00% by mass.

9. (canceled)

10. The method for producing electrofused alumina grains according to claim 7, wherein the amount of the zirconium compound blended in the step (A) of preparing the mixture material is such an amount that the zirconium content in terms of ZrO₂ in the ingot is from 0.01 to 2.00% by mass.

11. The method for producing electrofused alumina grains according to claim 7, wherein the amount of the zirconium compound blended in the step (A) of preparing the mixture material is such an amount that the zirconium content in terms of ZrO₂ in the ingot is from 40 mol to 67 mol relative to 100 mol in total of the tungsten content in terms of WO₃ and the molybdenum content in terms of MoO₃.

12. The method for producing electrofused alumina grains according to claim 7, wherein the heating temperature in the step (E) of producing the electrofused alumina grains is 1200° C. or higher and 1700° C. or lower.

13. A grindstone comprising the electrofused alumina grains according to claim 1.

14. A coated abrasive comprising the electrofused alumina grains according to claim 1.
